(19) United States
(12) Patent Application Publication
(10) Pub. No.: US 2003/0061995 A1
(43) Pub. Date: Apr. 3, 2003

(54) Devices and systems for providing animal-selective access to food

(76) Inventor: William Stanley Skeeles, Tucson, AZ (US)

Correspondence Address: THRASHER ASSOCIATES, LLP, 391 SANDHILL DR., RICHARDSON, TX, 75080, US

(21) Appl. No.: 09/963,436

(22) Filed: Sep. 28, 2001

(51) Int. Cl. A01K 1/10; A01K 5/00; A01K 39/00

(52) U.S. Cl. 119/51.01

(57) ABSTRACT

The invention provides a feeding enclosure system, and a method of providing selective animal access to food. The feeding enclosure system includes an enclosure having an orifice that is sized to selectively allow one animal to pass through while preventing a second animal from passing through, and a base configured for coupling to the enclosure. The method selects an orifice size of an enclosure configured to accommodate animal feeding, and removes material from an enclosure to create the orifice so that an animal may pass through the orifice while a second animal is prohibited from passing through the orifice.

### TECHNICAL FIELD

Generally, the invention relates to the field of pet supplies and accessories, and, more particularly, the invention relates to pet feeding devices.

### STATEMENT OF A PROBLEM ADDRESSED BY THIS INVENTION

With the proliferation of multiple animal/pet households, and with the domestication of outside pets, there is a problem with a pet or a wild animal consuming food that is prepared and set out for a specific pet. For example, dogs, such as pugs, often consume food that has been prepared specifically for a cat. However, the problem is not limited to dogs eating cat food.

As humans have encroached upon previously undeveloped land for building residential properties, wild animals are coming into more frequent contact with people and domesticated pets. Thus, other animals, such as deer, may eat food left for an “outdoor” pet. This is a hassle and forces the pet owner to frequently check a feeding bowl or dish to insure the pet has access to food. In addition, the increase in total consumption of food, particularly by wild animals, can increase food expenses.

For domesticated pets that are kept outside either occasionally or exclusively, the problem of restricting food to the intended animal/pet becomes much more important than a budgetary consideration or even an animal nutrition consideration. Attracting the wrong animal to a feeding location can result in more frequent human exposure to serious, even fatal diseases. As a result, humans are being exposed to such serious diseases as lime disease and rabies. And, as wild animals feed nearer to humans, the natural fear wild animals have of humans goes away, and the increased likelihood of close contact greatly increases the opportunity for disease transmission—particularly to children. Therefore, it is very important to limit the ability of such wild animals to regularly get food intended for domesticated pets.

Also, when an unintended animal consumes pet food, the intended pet recipient may go undernourished, and may revert to more instinctive (and dangerous) behavior—such as when a house cat is motivated to attack a pet bird or hamster, or even its owner. Furthermore, in domestic applications, sanitation can also be a problem if feeding dishes are placed in proximity to kitchen tables or countertops. Accordingly, this problem is a serious one when it involves only domesticated pets and the problem becomes even more troublesome when the animal “stealing” food is a wild animal.

Previous attempts to isolate pet food have not solved the aforementioned problems. In one approach a feeding source is positioned “out of the way” of a wild animal, such as placing cat food on a window sill to keep it away from deer. Keeping a feeding source positioned at out of the way locations makes it difficult and inconvenient for the owners to clean up and feed a pet, and may limit the availability of food to the pet as well (not to mention that finding an isolated spot that allows feeding of a domestic pet, while preventing access by a wild animal is practically very difficult). Accordingly, to overcome these and other disadvantages associated with existing methods of isolating pet food, it would be advantageous to have a feeding device that limits food access to specific animals.

### SELECTED OVERVIEW OF SELECTED EMBODIMENTS

The invention provides technical and operational advantages as a device and system for providing selective access to food, and is in one embodiment a feeding enclosure with a sized and positioned hole. In yet another embodiment, the invention is a system for providing selective access to food, and generally comprises an enclosure having a sized and positioned hole, as well as a base having a water and feeding dishes disposed therein.

In a method according to the invention a user selects a hole size and hole location, removes the hole from an enclosure configured to attach to a feeding base. The hole size and hole location are based on an animal that is to have access to food, and an animal that is to be excluded from food access. Accordingly, the selected hole size and hole location allows entry to the desired animal and blocks the entry at least a preselected animal.

Accordingly, the invention provides the advantages of: saving the cost of pet food consumed by other than the intended species, improving sanitation by allowing feeding to take place away from food intended for human consumption, and reducing disease transmission from animals to humans because unwanted animals will be blocked from entry to the feeding enclosure and, as a result, the opportunity for transmission of disease will be lessened. In addition, all of the aforementioned problems associated with the prior art are overcome by the invention.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention, and it should be understood that the invention is not limited by the detailed description. Accordingly, the invention should be read as being limited only by the claims.

### BRIEF DESCRIPTION OF THE DRAWINGS

Various aspects of the invention, as well as an embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 is a flow diagram of an enclosure operation;

FIG. 2 is one embodiment of a feeding enclosure; and

FIG. 3 illustrates one embodiment of a base.

### AN EXEMPLARY EMBODIMENT OF A BEST MODE

The invention provides inventive embodiments that allow desired animals or pets to have access to food while making the food inaccessible to unwanted pets or animals. One preferred method allows entry to the desired animal or pet through an orifice that has been sized and positioned in an enclosure cover to permit or restrict entry. This ensures that the desired animal/pet has access to a nourishing diet. Also, in the case of unwanted wild animals, the feeding enclosure can prevent access to diseased animals and, therefore, thwart the transmission of disease. Further, sanitation is improved when using the invention because a feeding enclosure embodiment can be placed in areas that will not contaminate human food.

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the claims section.

Exemplary Method

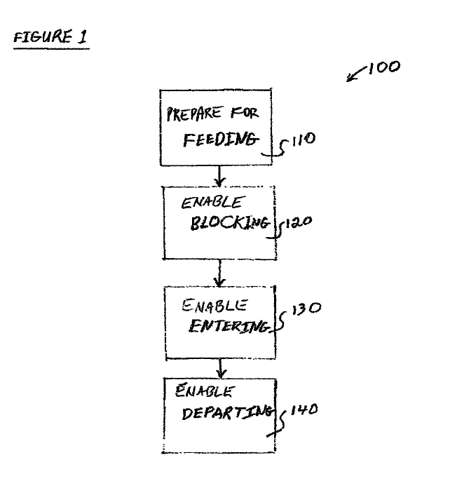

To more fully appreciate the invention, one may consider a feeding enclosure process according to the teachings of the invention. FIG. 1 illustrates a feeding enclosure process 100. The animal/pet feeding enclosure process (the process) 100 begins with a prepare for feeding act 110. In the prepare for feeding act 110 (the act 100) a user selects a hole size and hole location, and removes the hole from an enclosure configured to attach to a base. Accordingly, as discussed below, it should be understood that an enclosure may be provided with multiple hole sizes, or may be equipped in packaging with multiple hole-templates to facilitate the selection of a proper hole size.

In other embodiments, the holes will be of a preselected size, such as a size capable of supporting a cat. Likewise, the holes may be placed in pre-selected locations. In any event, the user selects the hole size and hole location based on an animal that is to have access to food, and an animal that is to be excluded from food access. Accordingly, the selected hole size and hole location allows entry to the desired animal and blocks the entry at least a preselected animal. Also in the prepare for feeding act 110, the enclosure is mated with a base, and a feeding dish (with food) is placed inside the feeding enclosure.

In operation, as unwanted animals or pets attempt to enter the enclosure, they are blocked from passage through an orifice in an enable blocking act 120. The blocking of entry into the feeding enclosure may be a result of the orifice being of a size that makes entry impossible, or a result of the orifice being placed in a location that makes access to food inside the enclosure impossible (since the unwanted species may lack the agility necessary to reach the position of the orifice—such as the top of the enclosure).

When a desired animal attempts to gain entry, an enable entering act 130 may be accomplished. In the entering act 130, an animal that the enclosure is designed and configured to accommodate enters the enclosure, presumably to access food. The enable entering act 130 is properly executed as a result of an appropriate orifice being sized and positioned to allow passage of the desired animal. Then, after food consumption has taken place, animal needs to leave the food enclosure. The departure may naturally be enabled by the same orifice to which access was granted. However, to facilitate departure for other animals, departure-assistance devices may need to be installed. The creation of an orifice, or, when needed, the placement of departure-assistance devices, constitute a departing act 140. Thus, the animal that obtained access to food may also exits the feeding enclosure.

Exemplary Device

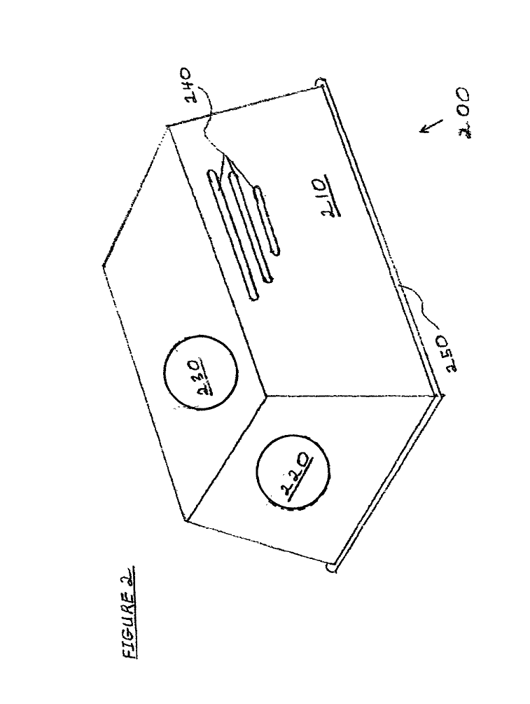

FIG. 2 is an embodiment of a feeding enclosure (the device) 200. The device 200 generally comprises an enclosure having at least one orifice, such as a first orifice 220 and a second orifice 230. Each orifice 220, 230 is sized and located on the enclosure so as to allow entry to a desired animal/pet species and prohibit entry to larger or less dexterous species. In addition, although circular orifices 220, 230 are illustrated in FIG. 2, it should be understood that an orifice may have any geometric shape, such as an oval, or octagon.

For example, in one embodiment, an orifice 230 could be sized and positioned in a top location on the enclosure 210 so as to allow entry to a cat, while also being sized and positioned to block entry by a dog, such as a pug. An orifice 220 located on a side of the enclosure 210 could be used by less agile species by relying on size (for example, cats can “squeeze through a small orifice, while the broad shoulders of a dog will prevent entry through the same small orifice). It is sometimes preferred to coat an orifice with a protective material, such as foam or trim moulding, to prevent injury to an animal.

It is preferable to provide slotted openings 240 to ensure adequate circulation of air for breathing. Also, in a preferred embodiment, securable doors 280 are located on the enclosure as a means for providing access to food and water supplies. In some embodiments, an attachable base 250 could be fitted to the device 200 to create a system to allow for improved entry blockage and cleanliness.

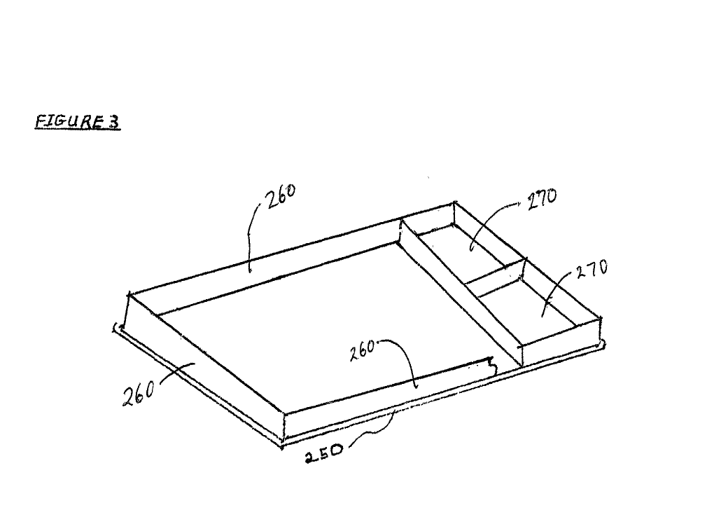

FIG. 3 provides a cut-view of the device 200 to illustrate preferred aspects of the base 260 . The base is preferably comprised of a side-barrier 260 to prevent spillage of food and/or water when the enclosure 210 is removed from the base 250. In a preferred embodiment, the base maintains means for securing food and water dishes, and may incorporate integral food and/or water trays 270 (that may function as means for securing). It is advantageous to locate the food and water trays 270 adjacent to the securable doors of the enclosure 210.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

I claim:

1. A method for operating a feeding enclosure, comprising:
selecting an orifice size of an enclosure configured to accommodate animal feeding; and
removing material from an enclosure to create the orifice so that an animal may pass through the orifice while a second animal is prohibited from passing through the orifice.

2. The method of claim 1 further comprising selecting an orifice location.

3. The method of claim 1 wherein the enclosure is sufficiently large to allow an adult cat to pass through.

4. The method of claim 1 wherein the orifice is circular.

5. The method of claim one wherein the orifice has a foam lip.

6. The method of claim 1 further comprising disposing the enclosure on a base.

7. The method of claim 6 further comprising placing an departure enabling device in the enclosure.

8. The method of claim 1 wherein the orifice is sufficiently small to prevent a predetermined animal from passing through the orifice.

9. A feeding enclosure system, comprising:
an enclosure having an orifice that is sized to selectively allow one animal to pass through while preventing a second animal from passing through; and
a base configured for coupling to the enclosure.

10. The feeding enclosure of claim 9 wherein the enclosure provides at least one air passage.

11. The feeding enclosure of claim 9 wherein the orifice is located at the top of the enclosure.

12. The feeding enclosure of claim 9 wherein the orifice is located at a side of the enclosure.

13. The feeding enclosure of claim 9 wherein the enclosure comprises a means for accessing a feeding dish.

14. The feeding enclosure of claim 13 wherein the means for accessing comprises securing doors.

15. The feeding enclosure of claim 9 wherein the base comprises a side barrier.

16. The feeding enclosure of claim 9 wherein the enclosure is coupled to the base.

17. The feeding enclosure of claim 9 wherein the orifice includes a foam lip.
